(19) United States
(12) Patent Application Publication
(10) Pub. No.: US 2004/0016129 A1
(43) Pub. Date: Jan. 29, 2004

(54) Portable handheld powered envelope opener with grip handle

(76) Inventors: Anthony J. Lammers, Gates Mills, OH (US); John R. Nottingham, Bratenahl, OH (US); John W. Spirk, Gates Mills, OH (US); Jeffrey Scott Plantz, Medina, OH (US); Patrick W. Brown, Auburn, OH (US)

Correspondence Address: DKW LAW GROUP, P.C., 58TH FLOOR - USX TOWER, 600 GRANT STREET, PITTSBURGH, PA, 15219, US

(21) Appl. No.: 10/205,525

(22) Filed: Jul. 25, 2002

(51) Int. Cl. B26B 15/00

(52) U.S. Cl. 30/264; 30/265; 30/263

(57) ABSTRACT

A portable, handheld envelope opening device is disclosed. The envelope opening device has a head portion and a handle portion. The head portion includes a slot defined by a pair of opposing walls and a base plate. The walls being spaced so as to guide the passage of an envelope and preferably are slightly angled to provide a tapered insertion end. A pair of rotary discs disposed within the head portion adjacent the base plate intersects in partially overlapping fashion along a centerline of said slot. The discs are spaced and positioned adjacent the base plate. The first disc includes a cutting edge, and the second disc is adapted to urge the envelope into engagement with the first cutting disc to sever a marginal edge of the envelope to expose the contents. A motor is coupled through a gearbox to the rotary discs to drive the discs. A switch is used to couple the motor to a battery power supply. In one embodiment, a decorative edge is applied to the envelope but the cutting disc by providing a sawtooth or undulating cutting edge on the disc.

### RELATED APPLICATIONS

There are no applications related to this invention anywhere in the world.

### BACKGROUND OF THE INVENTION

1. Field of the Invention

The present invention relates to envelope openers and, more particularly, to portable, handheld, motor-driven envelope or letter openers with grip handles.

2. Description of the Prior Art

Various envelope openers exist in the prior art. Some of these envelope openers, particularly those with power-driven cutting blades, are large devices intended for use on a desktop or work surface, but are unwieldy, expensive and not practical for portable use, for example, in a briefcase, desk drawer or portable computer carrier. Other openers that are more compact do not include power-driven cutting blades or lack sufficient means for gripping such a compact device.

U.S. Pat. No. 2,656,889 discloses an automatically operated cutting wheel for opening envelopes. The envelope opener is placed on a table or desk in a place of business. A pair of co-acting cutting elements is disposed adjacent to a suitable cutting guide for guiding envelopes into engagement with the cutters. A motor is operatively connected thereto and the motor operates automatically by a control switch actuated by movement of an envelope through the guide slot.

U.S. Pat. No. 3,597,843 discloses a device for opening envelopes. A rectangular block, sized to be held in the hands of a user, is provided with an elongated guide slot through which the edge of an envelope is directed, and a two-part rotatable cutting means journaled into the block has a cutting nip formed in the slot so that the edge of the envelope will be severed as it moves relative to the block.

U.S. Pat. No. 5,127,161 discloses a cutter for cutting an envelope along an edge. An envelope is slid with its edge in contact with a sliding surface perpendicular to a floor. The envelope or other item to be cut is pressed against the sliding surface with a press means when cut with a blade edge at a given distance from the envelope edge approximately straight and parallel to the edge.

Hence, there exists a need for a compact, motor-driven portable letter opener having a grip handle.

### SUMMARY OF THE INVENTION

It is an object of the present invention to provide a motor-driven envelope opener suitable for cutting an edge of an envelope to expose the contents thereof, which is both portable and compact and has a handle for gripping the device while in use.

It is another object of the present invention to provide a switching means disposed on the handle portion which is operable by the user, such as by a momentary contact switch, for actuating the motor when sliding an envelope through the cutting guide.

It is a further object of the present invention to provide a pair of cooperable cutting discs or wheels, one wheel having a sharp peripheral edge and the second having a peripheral traction edge, for simultaneously pulling and cutting an envelope edge.

It is yet another object of the present invention to provide a battery storage chamber in a handle portion for powering an electric motor that drives the pair of cutting discs.

Another object of the present invention is to provide a miniature gearbox for reducing the speed of the output shaft of the gearbox relative to the speed of the motor input shaft so as to apply the appropriate speed and torque at the cutter block for shearing an edge from an envelope.

What is disclosed is a portable, handheld envelope opening device. The device includes a housing with a head portion and a handle portion. The head portion has a slot defined by a pair of opposing walls and a base plate. The walls are spaced so as to guide the passage of an envelope through the slot.

A pair of rotary discs is disposed within the head portion. The discs are adjacent the base plate and intersect in a partially overlapping fashion along a centerline of the slot. Discs are spaced in close proximity to the base plate. In the preferred embodiment, the first disc includes a cutting edge, and the second disc is adapted to frictionally urge the envelope into engagement with the first cutting disc adjacent an edge of the envelope to sever a marginal edge of the envelope to open it.

Drive means is disposed within the handle portion to drive the rotary discs. The drive means is coupled to the discs through a power transfer gearcase. There is also a power source to power the drive means and a switching means for coupling the drive means to the power source to energize the drive means.

### BRIEF DESCRIPTION OF THE DRAWINGS

FIG. 1 is a perspective view of the preferred embodiment of an envelope opener;

FIG. 2 is a cross-sectional elevational view of the envelope opener taken along lines 2-2 in FIG. 1;

FIG. 3 is a cross-sectional elevational view of the envelope opener taken along lines 3-3 in FIG. 2;

FIG. 4 is a cross-sectional view taken along lines 4-4 in FIG. 3;

FIG. 5 is an exploded view showing the assembly arrangement of the gearbox;

FIG. 6 is a perspective view of the gearbox assembly with the cover detached;

FIG. 7 is an alternate sawtooth-cutting blade; and

FIG. 8 is an alternate wave-cutting blade.

### DETAILED DESCRIPTION OF THE INVENTION

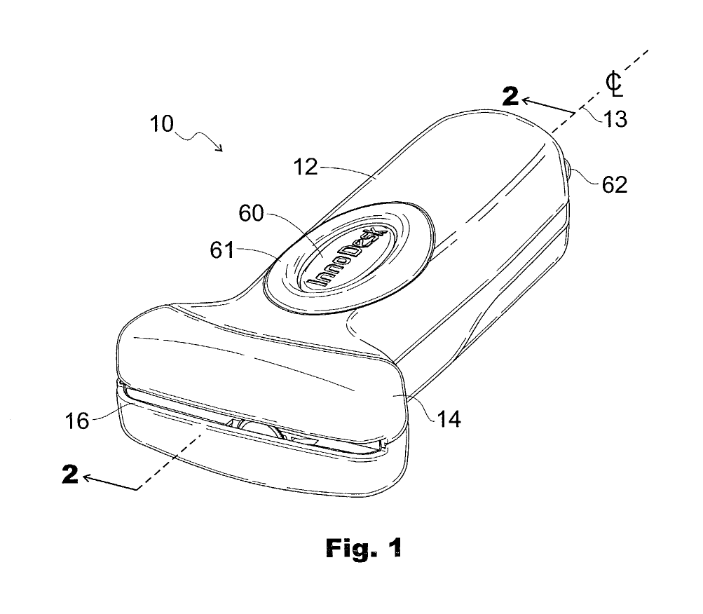

Referring first to FIG. 1, an envelope opening device 10 has a head portion 14 connected to a handle portion 12. The head portion 14 contains a guide slot 16 comprising a narrow passage through which an envelope (not shown) may be passed. The guide slot 16 traverses the entire width of head portion 14 in a direction perpendicular to the direction of an axis 13 of handle portion 12. Handle portion 12 includes a switch 60, which can be operated by the user's thumb when gripping the handle portion 12 in one hand, thus leaving the user's remaining hand free to manipulate an envelope through the guide slot 16. A raised collar 61 surrounds the switch 60. The raised collar 61 projects upward slightly beyond the raised portion of switch 60, so that the switch 60 will not be accidentally operable when laid on a surface with the switch facing down. A string 62 is attached at the distal end of handle portion 12 opposite head portion 14 providing means for attaching the envelope opening device 10 to a clip or a hook or the like (not shown).

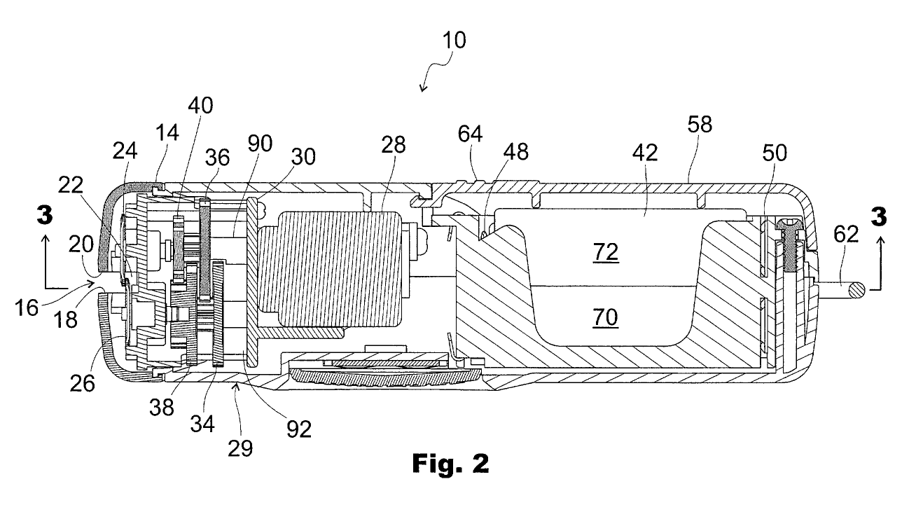

Referring next to FIGS. 2, 3, 5 and 6, the views show a gearbox 29 and cutter discs 24, 26. Four gears 34, 36, 38 and 40 are employed in the disclosed embodiment to transfer the torque from a shaft 32 of a motor 28 to the cutter blade disc 24 and nip roller disc 26. Nip roller disc 26 preferably includes edge serrations 27 about the periphery of the disc 26 to provide frictional engagement of the envelope. Other frictional engagement means may be employed, such as a rubber rim or knurled edge, as is well known in the art. Gears 34, 36, 38 and 40 are housed within the gearbox assembly 29. Gears 34, 36, 38 and 40 are step gears arranged along parallel axes extending from the shaft 32 of motor 28. Step gear 34 is attached to a first axle 84, which is seated in a socket 92. The step portion of gear 34 engages gear 36, which is attached to a second axle 86, seated in a socket 90. Step portion of the gear 36 engages gear 38, which is coupled to axle 84 by a hexagonal center portion 85. Axle 84 fastened directly to nip roller disc 26. Gear 38 also engages gear 40, which is similarly coupled to axle 86 by a hexagonal center portion 87. Axle 86 is directly attached to cutter blade 24. When the motor 28 is energized by operation of the thumb switch 60, the third and fourth drive gears 38, 40 cause the roller disc portion 26 and cutter blade disc 24 to rotate in opposite directions. It will be recognized that the cutter blade 24 and roller disc 26 may be switched in this arrangement to achieve the same result.

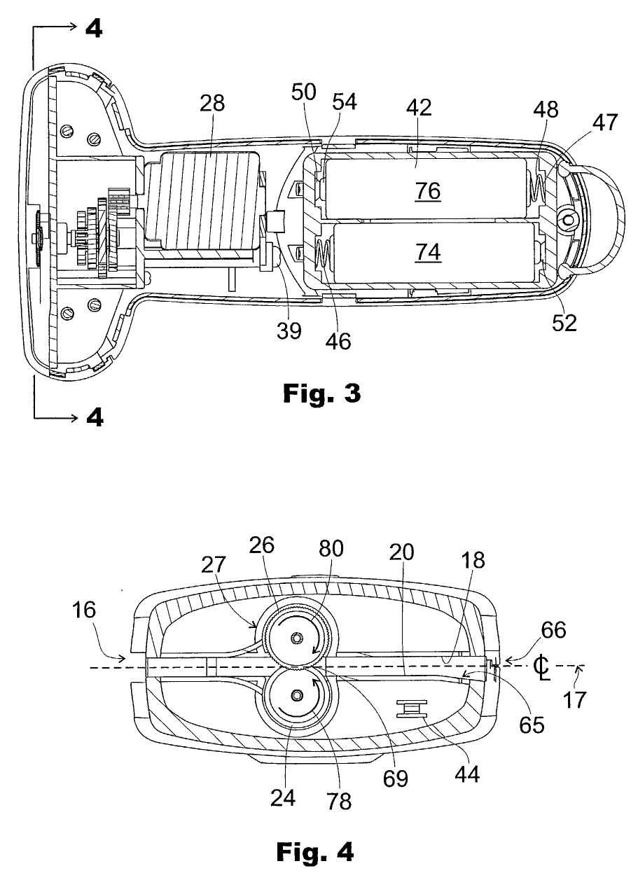

Motor 28 is a miniature DC motor, which is mounted to a first gearbox plate 30. Drive gear 37 extends through first gearbox plate 30 to engage gear 34. Drive gear 37 and motor shaft 32 are positioned off-center, as illustrated more clearly in FIG. 3. Motor 28 is also retained in place by a fastener 39. Other arrangements of gears may be employed to effect the same or similar speed reduction and coupling between the motor 28 and discs 24, 26.

Power for the motor 28 is supplied from a battery compartment generally designated as 42, which houses four AA batteries 70, 72, 74 and 76 as disclosed in the preferred embodiment. Batteries are maintained in place by retainer springs 46, 48 and 45, 47. Each spring is mounted opposite a pressure contact 50, 52, 54 and 56 (not shown) and connected in series to provide an electromotive force (EMF) to power the DC motor. Other battery types and DC power supply arrangements will be equally useful so long as the voltage is compatible with the motor that is employed.

A battery door 58 is provided. Door 58 slides retentively into position and has raised portions 64 for providing a gripping surface to frictionally disengage the door from the handle portion 12.

Referring next to FIG. 4, a sectional view taken along the lines 4-4 in FIG. 3 shows a sectional view of the arrangement of the cutter blade 24 and the roller disc portion 26. A tapered mouth 66 is formed by an angled portion 65 of a second wall 20 away from a first wall 18 at guide slot 16. The mouth provides a slightly larger entry into the slot to assist in guiding the envelope into the narrow passage of guide slot 16. A base plate 22 of the slot 16 is spaced slightly below cutter and roller discs 24, 26, which are circular and partially intersect at approximately the centerline 17 of slot 16. The intersection of discs forms a nip 69 into which an edge of the envelope is directed. Rotation arrows 78, 80 display the direction of rotation of the circular discs 24, 26, which enables roller disc 26 to engage the envelope and “pull” the envelope into the nip 69 and toward the discharge end of guide slot 16 while the cutting blade 24 rotating in the opposing direction of roller disc portion 26 also cuts the envelope rotating in the direction toward the discharge of the guide slot 16. This juncture of the two discs forms a nip 69 for grasping and cutting the narrow margin of an edge of the envelope. Other combinations of discs may be employed, such as where both discs are sharpened cutter discs 24, or both discs include frictional discs 26.

A set of electrical contacts 44 may optionally be included to sense the presence of an envelope in the slot 16. These contacts are pressure sensitive and are designed to close by the pressure applied by the envelope against inner walls 18, 20 as an added precaution against leaving the unit run when not in use.

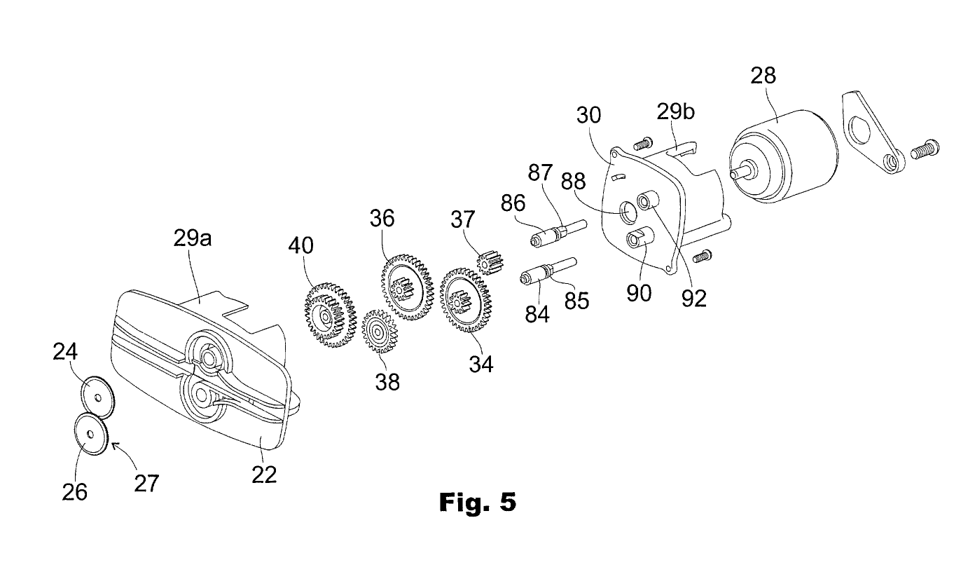

Referring next to FIG. 5, there is an exploded view showing the arrangement in the gearbox assembly 29. The frame for gearbox assembly 29 is comprised of two shell portions 29a and 29b, which are fastened together with screws or equivalent fasteners. The motor 28 has the main drive gear 37 attached to the shaft (not shown) and penetrates through the gearbox assembly 29b through an aperture 88. Sockets 90, 92 are positioned on opposite sides of aperture 88 to provide parallel mounting seats for axles 84, 86. The drive gear 37 engages the teeth of the first step gear 34 at its widest diameter. A step gear has two different radii, each containing teeth about the periphery: the outermost radius engaging the drive gear 37 and the inner radius teeth engaging the outer radius of the next adjacent step gear, in this case second step gear 36. The inner radius gear on step gear 36 similarly engages step gear 40. Step gear 40 engages gear 38. Gear 38 is preferably a spur gear type. Another step gear is not required at the end of the gear train. Axles 84, 86 project through the two parallel axes of gear trains. Axles 84, 86 penetrate through gearbox assembly top portion 29a and are coupled to cutter blade 24 and roller disc 26. The axles 84, 86 are driven by the outermost gears 40, 38 in the gear trains to achieve the appropriate speed reduction from the motor drive shaft 37.

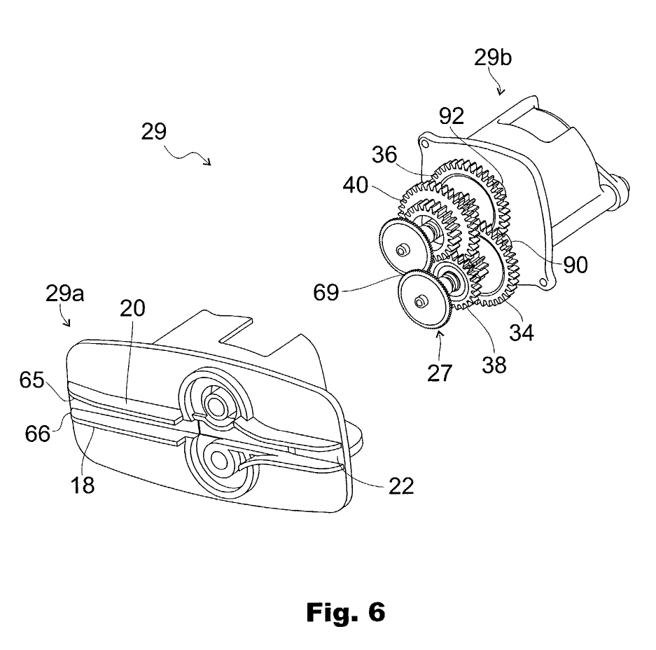

Referring next to FIG. 6, the assembly 29 is shown in the assembled stage with the top portion 29a removed for illustrative purposes. The cutter blade 24 and roller disc portion 26 are illustrated in a vertically offset, horizontally overlapping relationship so as to permit simultaneous rotation without interference, forming the nip.

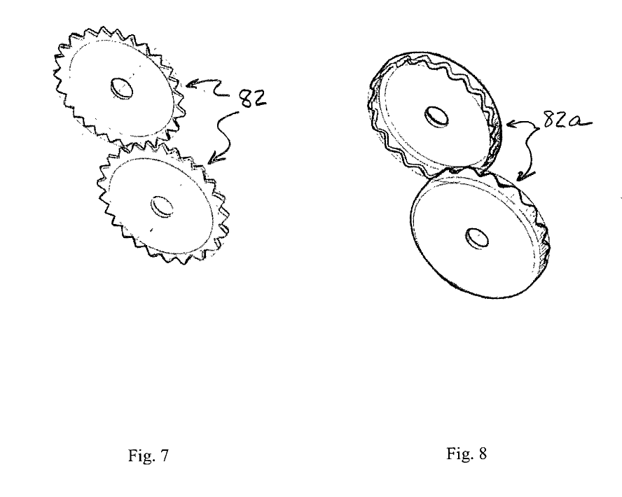

In an alternate embodiment, the opener 10 would cut a sawtooth edge or wavy edge (not shown) similar to pinking shears. Referring to FIGS. 7 and 8, cutting discs 82 and 82a are illustrated. Blade 82 is an alternative blade to a simple straight edged disc, wherein the edge of the alternate disc has an undulating wavy profile; or alternately, the cutting blade 82a of FIG. 8 has an edge in the profile of a sawtooth. These blades may be used in place of a straight-edged disc. The alternative blades cut an edge on an envelope similar to their profiles. After cutting the edge margin from an envelope, it is readily apparent that the envelope has been opened so that the user does not repeat the process of opening the envelope and in the process mutilating the contents of the envelope on the second or subsequent pass.

With the disclosed invention, the user may easily grasp the handle portion 12 in the palm of either hand, and the thumb is free to operate switch 60. With his or her free hand, the user directs an envelope into the mouth 66, holding the envelope vertically against slot base plate 22. The user then urges the envelope further into guide slot 16 into contact with the nip 69 formed by the intersection of roller disc portion 26 and cutter blade 24. Mouth 66 is preferably tapered slightly to facilitate guiding the envelope into the slot 16.

When the thumb switch 60 is depressed, roller disc 26 and cutter 24 rotate so that they pull the envelope into the nip 69 and shear the edge of the envelope. The roller and cutter discs 26, 24 will rotate as long as the switch 60 is maintained in the closed position. A hair switch (not shown) may be optionally employed to sense that an envelope is present in the guide slot 16. An envelope positioned in guide slot 16 will deflect a “hair” sensor arm causing the microswitch (not shown) to close a set of contacts in series with thumb switch 60. In this way, in order for the motor to be switched to the “on” position, a user must have an envelope in position in guide slot 16, while depressing the thumb switch 60. The hair switch (not shown) may be used as a substitute for pressure sensitive contacts 44.

The use of a hair switch or a set of pressure contacts ensures that the unit cannot run, for example, if the switch is left in the on position without an envelope in guide slot 16; thus the accidental drain of battery power is prevented. This is merely one example of preventing the unit from running when not in use. Those skilled in art will recognize alternative means, for example, a spring-return, momentary contact switch or a latching time-out circuit, all of which are intended to be within the scope of the appended claims.

The momentary-contact switch on the handle also provides a means for test operation that may be used in the original packaging. The momentary operation of the switch permits the user to operate the device 10 while still wrapped in protective packaging. A transparent thin plastic barrier (not shown) is molded around a portion of the device 10 and adhesively or mechanically attached to a backing sheet of cardboard (also not shown), with the device secured between the plastic barrier and the cardboard. The plastic is pliable so that the pushbutton on the switch may be depressed to turn on the device while on the store shelf. The switch is returned to the off position when released, thereby avoiding unintended drainage of the batteries in the packages. This feature advantageously invites people to test-operate the device.

The envelope-opening device may also be adapted so that each of the discs 24, 26 is each slightly tilted. This way the discs are in planes intersecting at an oblique angle with the base plate so as to pull the envelope downward into contact with the base plate 22. This adaptation tends to prevent an envelope from “slipping” from the slot before the envelope is completely open.

According to the provisions of the patent statutes, we have explained the principle, preferred construction, and mode of operation of the invention, and have illustrated and described what we now consider to represent its best embodiments. However, it should be understood that within the scope of the appended claims and the foregoing description, the invention may be practiced, otherwise than specifically illustrated and described.

We claim:

1. A portable, handheld envelope opening device comprising:
a housing having a head portion and a handle portion;
said head portion including a slot defined by a pair of opposing walls and a base plate, said walls being spaced so as to guide the passage of an envelope therebetween;
a pair of rotary cutting discs disposed within said head portion adjacent said base plate and intersecting in partially overlapping fashion along a centerline of said slot, spaced from and proximate to said base plate; said pair of cutting discs cooperable to urge an envelope into engagement with each other adjacent an edge of the envelope to sever a marginal edge of the envelope to expose the contents therein;
drive means disposed within said handle portion; and
means coupled to said discs for transferring power from the drive means.

2. The envelope opening device as set forth in claim 1, wherein at least a portion of one or more of said pair of opposing walls is angled slightly from parallel to the centerline of said slot to form a tapered insertion opening for guiding an envelope into the slot more easily.

3. The envelope opening device as set forth in claim 1, wherein said means for transferring power comprises a gearbox assembly, said gearbox assembly also comprising a plurality of step gears arranged coaxially along at least two axes to simultaneously drive said pair of discs at a reduced speed relative to said drive means.

4. The envelope opening device as set forth in claim 3, wherein said drive means is comprised of an electric motor.

5. The envelope opening device as set forth in claim 4 also including a power source; and
switching means for coupling said drive means to said power source to energize said drive means.

6. The envelope opening device as set forth in claim 1, wherein said first disc including a cutting edge, and said second disc is adapted urge the envelope into engagement with the first cutting disc.

7. The envelope opening device as set forth in claim 6, wherein said second disc also having a serrated edge for grasping the envelope while passing through the slot.

8. The envelope opening device as set forth in claim 1, wherein said cutter having an undulating peripheral edge causing the margin edge of the envelope to have a wave profile after cutting the envelope by passing it through the slot.

9. The envelope opening device as set forth in claim 1, wherein said cutter having a sawtooth peripheral edge causing the margin edge of the envelope to have a sawtooth profile after cutting the envelope by passing it through the slot.

10. The envelope opening device as set forth in claim 1, wherein also providing a loop at a distal end of said handle for attaching said envelope opener to one of either a clip or a hanger device.

11. The envelope opening device as set forth in claim 1, wherein said switching means comprises a momentary contact switch.

12. The envelope opening device as set forth in claim 1, wherein said switching means comprises a deflection arm transversely disposed across the slot to automatically actuate said drive means when an envelope is passed through the slot.

13. The envelope opening device as set forth in claim 1, wherein said envelope opening device also includes a sealed package having a means for momentarily operating said device while the device is inside the package, and for automatically returning said device to an inoperative state.

14. The envelope opening device as set forth in claim 5, wherein said power source comprises one or more batteries.

15. The envelope opening device as set forth in claim 1, wherein said pair of cutting discs comprises the grouping selected from one of the following combinations:
a sharp edged blade and a serrated edge blade; a pair of sharp edged blades; and a pair of serrated edge blades.

16. The envelope opening device as set forth in claim 1, wherein said pair of discs are each slightly tilted in planes intersecting at an oblique angle with said base plate so as to urge the envelope into contact with said base plate.

17. A portable, handheld envelope opening device comprising:
a housing having a head portion and a handle portion;
said head portion including a slot defined by a pair of opposing walls and a base plate, said walls being spaced so as to guide the passage of an envelope therebetween;
a pair of rotary discs disposed within said head portion adjacent said base plate and intersecting in partially overlapping fashion along a centerline of said slot spaced from and proximate to said base plate; said first disc including a cutting edge, and said second disc is adapted urge the envelope into engagement with the first cutting disc adjacent an edge of the envelope to sever a marginal edge of the envelope to expose the contents therein;
a motor disposed within said handle portion;
a gearbox assembly coupled to said discs for transferring power from the motor, said gearbox assembly also comprising a plurality of step gears arranged coaxially along at least two axes to simultaneously drive said pair of discs at a reduced speed relative to said motor;
a compartment for containing one or more batteries to energize said motor; and
a switch disposed on the outside of said handle portion for electrically coupling the drive means to said one or more batteries to energize said drive means.

18. The envelope opening device as set forth in claim 17, wherein at least a portion of one or more of said pair of opposing walls is angled slightly from parallel to the centerline of said slot to form a tapered insertion opening for guiding an envelope into the slot more easily.

19. The envelope opening device as set forth in claim 17, wherein said pair of discs are each slightly tilted in planes intersecting at an oblique angle with said base plate so as to urge the envelope into contact with said base plate.

20. The envelope opening device as set forth in claim 17, wherein said second disc also having a serrated edge for grasping the envelope while passing through the slot.

21. The envelope opening device as set forth in claim 17, wherein said first disc having an undulating peripheral edge causing the margin edge of the envelope to have a wave profile after cutting the envelope by passing it through the slot.

22. The envelope opening device as set forth in claim 17, wherein said cutter having a sawtooth peripheral edge causing the margin edge of the envelope to have a sawtooth profile after cutting the envelope by passing it through the slot.

23. The envelope opening device as set forth in claim 17, wherein also providing a loop at a distal end of said handle for attaching said envelope opener to one of either a clip or a hanger device.

24. The envelope opening device as set forth in claim 17, wherein said switch comprises a momentary contact switch and also including a raised collar portion peripherally to prevent accidental activation of the switch.

25. The envelope opening device as set forth in claim 17, wherein said envelope opening device also includes a sealed package with a means for momentarily operating said device while the device is inside the package, and automatically returning said device to an inoperative state.

26. A portable, handheld envelope opening device comprising:
a housing having a head portion and a handle portion;
said head portion including a slot defined by a pair of opposing walls and a base plate, said walls being spaced so as to guide the passage of an envelope therebetween;
at least a portion of one or more of said pair of opposing walls is angled slightly from parallel to the centerline of said slot to form a tapered insertion opening for guiding an envelope into the slot more easily;
a pair of rotary discs disposed within said head portion adjacent said base plate and intersecting in partially overlapping fashion along a centerline of said slot spaced from and proximate to said base plate; said first disc including a cutting edge, and said second disc having a serrated edge to urge the envelope into engagement with the first cutting disc adjacent an edge of the envelope to sever a marginal edge of the envelope to expose the contents therein;
said pair of discs each slightly tilted in planes intersecting at an oblique angle with said base plate so as to urge the envelope into contact with said base plate;
a motor disposed within said handle portion;
a gearbox assembly coupled to said discs for transferring power from the motor, said gearbox assembly also comprising a plurality of step gears arranged coaxially along at least two axes to simultaneously drive said pair of discs at a reduced speed relative to said motor;
one or more batteries to energize said motor;
a switch disposed on the outside of said handle portion for electrically coupling the drive means to said one or more batteries to energize said drive means; and
wherein said first disc having an undulating peripheral edge causing the margin edge of the envelope to have a wave profile after cutting the envelope by passing it through the slot.

27. The envelope opening device as set forth in claim 26, wherein said cutter having a sawtooth peripheral edge causing the margin edge of the envelope to have a sawtooth profile after cutting the envelope by passing it through the slot.

28. The envelope opening device as set forth in claim 26, wherein also providing a loop at a distal end of said handle, for attaching said envelope opener to one of either a clip or a hanger device.
